(19) United States
(12) Patent Application Publication
(10) Pub. No.: US 2010/0165320 A1
(43) Pub. Date: Jul. 1, 2010

(54) METHOD FOR MOUNTING AND ADJUSTING AN ELECTRO-OPTICAL DEVICE AND MEASURING DEVICE MOUNTED AND ADJUSTED BY MEANS OF SUCH A METHOD

(75) Inventors: Peter Wolf, Leinfelden-Echterdingen (DE); Uwe Skultety-Betz, Leinfelden-Echterdingen (DE); Gunter Flinspach, Leonberg (DE); Joerg Stierle, Waldenbuch (DE); Bjoern Haase, Stuttgart (DE); Kai Renz, Leinfelden-Echterdingen (DE)

Correspondence Address: MICHAEL J. STRIKER, 103 EAST NECK ROAD, HUNTINGTON, NY, 11743, US

(73) Assignee: ROBERT BOSCH GMBH, Stuttgart (DE)

(21) Appl. No.: 11/993,524

(22) PCT Filed: Aug. 7, 2006
(86) PCT No.: PCT/EP2006/065109

§ 371 Date: Dec. 21, 2007

(30) Foreign Application Priority Data
Sep. 20, 2005 (DE) 102005044770.8

(51) Int. Cl. G01C 3/00; B29C 65/00; B29C 65/08

(52) U.S. Cl. 356/3; 156/60; 156/73.1

(57) ABSTRACT

The invention relates to a method for mounting and alignment of an electro-optical apparatus, in which an optic (42) is oriented in three axes (X;Y;Z) relative to a further component (26, 46), in particular a method for alignment of a receiving optic (42) relative to an optical receiver (46). The invention proposes that the optic (42) is first aligned in a first (X) and a second direction (Y) and the optic (42) is subsequently fixed to an optical carrier (40) in the third direction (Z) by means of a welding process. The invention furthermore relates to a measuring device, in particular a distance measuring device (10), aligned according to the method of the invention.

The present invention relates to a method for assembly and adjustment of a first element, which forms an image of a measurement signal and is situated on a supporting element. In this assembly, the image-forming element is adjusted in relation to a second element that receives the measurement signal. The present invention also relates to a measuring device assembled and adjusted according to a method of this kind.

### PRIOR ART

Electro-optical measuring devices with image-forming or focusing optics must be precisely adjusted so that a measurement signal to be evaluated can be conveyed with sufficient quality to a receiver of the device. There are already a multitude of known methods for adjusting image-forming elements in relation to an associated receiver element.

DE 10314772 A1 has disclosed a device for adjusting an optical mirror in an optical measuring device that has a mirror support—which accommodates a mirror and is secured on a support profile—and also has three adjusting pins passing through threaded bores arranged offset from one another in the circumference direction in the mirror support. The adjusting pins, which can be moved axially by being screwed into the threaded bores, rest with their base points against abutments embodied on the support profile. For the sake of a precise, rapid adjustment of the mirror, the abutments are embodied so that on the one hand, they center the mirror support by means of the adjusting pins and on the other hand, at least two abutments each permit a radial drift of the base point of their respective adjusting pin.

### ADVANTAGES OF THE INVENTION

A method according to present invention for assembly and adjustment of optics relative to a receiver element, in particular such a method for adjusting receiving optics in an optics support, with the defining characteristics of claim 1, has the advantage that it permits the rapid, precise adjustment of an optical system without requiring further work such as an additional fixing or sealing of the optical element. With the method according to the present invention for adjusting of a first element, which is embodied in the form of optics—for example receiving optics—that form an image of a measurement signal, in relation to a second element, which receives the measurement signal—for example a photo diode, the optics are first adjusted in a first and second direction in that for example the optics are moved into position in the X and Y directions and secured in place. Then, the optics are adjusted in the third direction (Z direction) and fixed in place by means of a welding process.

This permits a simple, rapid adjustment, particularly of electro-optical measuring devices such as distance measuring devices since the optics, in particular the receiving optics, are adjusted and not the electronic or electrical components of the measuring system. In addition, the assembly and adjustment method according to present invention does not require any additional fixing elements such as clamping screws in order to secure the completed adjustment. After the welding process according to the present invention, the optics, in particular receiving optics of an electro-optical measuring device, are both aligned in their position and fixed in position. Consequently, the optics do not need to be additionally secured, for example by means of adhesive or clamping screws.

Furthermore, additional components such as deflecting mirrors are not required with this simple triaxial adjustment, making it possible to implement an optical measuring device in a compact, reasonably priced form, which assures the required precise adjustment of its electro-optical components despite its compact design.

Advantageous modifications of the method according to the present invention are possible by means of the defining characteristics cited in the dependent claims.

The position of the optics in the third direction to be adjusted (Z direction) can advantageously be adjusted by means of at least one parameter of the welding process. For example, the position of the optics can be adjusted by means of the duration of the welding process.

In an advantageous embodiment of the method according to the present invention, the optics and/or the optics support that accommodates the optics has at least one energy-conducting edge that conducts the energy released during the welding process. Since the energy-conducting edge can advantageously be embodied as conical, this produces a correspondingly elevated energy density therein so that the energy-conducting edge is melted with a corresponding intensity as a function of parameters of the welding process. After the adjusting process, i.e. after the completion of the welding procedure, this energy-conducting edge advantageously produces a solid connection between the optics and the optics support. Consequently, through dimensioning of the energy-conducting edge, it is advantageously possible to adjust the position of the optics during the welding/adjusting process.

It is thus possible, for example, to adjust the position of the optics in the third direction to be adjusted (Z direction) by means of a pressure of the welding device or of a component of the welding device.

In an advantageous embodiment of the method according to present invention and of a measuring device manufactured using the method according to present invention, the optics are composed of plastic. This advantageously permits the use of an ultrasonic welding process for the assembly and adjustment of the optics. It is thus possible, for example, through a corresponding dimensioning of the energy-conducting edge on the optics or on the support, to adjust the distance setting of the optics, for example a receiving lens, to a receiver by means of the welding parameters, for example the interaction time, the pressure, or the frequency.

With this method, the optics are advantageously adjusted so that the optical axis defined by the optics, for example the reception axis of a biaxial optical system, is, at a certain distance, aligned centrally with a second optical axis, for example the transmission axis of the same optical biaxial system.

In an advantageous embodiment of the method according to present invention, this adjustment process is automated by means of a control loop so that the adjusting welding process is controlled by means of a corresponding control variable such as the distance of the optics from the receiver element or the signal strength of the optical measurement signal detected with the receiver element.

The method according to the present invention for assembly and adjustment of an image-forming element, for example a set of optics, in relation to a receiving element, for example a photo diode, makes it possible to embody a measuring device, in particular a distance measuring device, with very compact dimensions. This makes it possible to implement an optical distance measuring device, in particular a hand-held laser distance measuring device, in the form of a compact, reasonably priced measuring device.

Other advantages of the method according to present invention and of a measuring device adjusted by means of this method ensue from the following description of an exemplary embodiment.

### DRAWINGS

The drawings show an exemplary embodiment of a measuring device adjusted by means of the method according to present invention, which embodiment is used to illustrate the method in the subsequent description. The figures of the drawings, their description, and the claims contain numerous features in combination. Those skilled in the art will also consider these features individually and unite them in other meaningful combinations.

FIG. 1 gives a perspective overview of an electro-optical distance measuring device,

FIG. 2 is a view from below of an optics support with adjusted optics,

FIG. 3 is a front view of the optics support with adjusted optics corresponding to FIG. 2,

FIG. 4 is a detail of the flank zone between the optics and optics support according to FIG. 2.

### DESCRIPTION OF AN EXEMPLARY EMBODIMENT

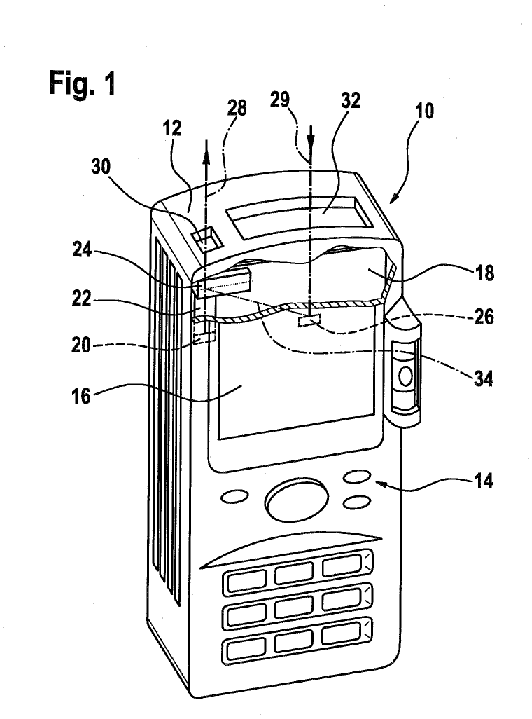

FIG. 1 shows a electro-optical measuring device 10 embodied in the form of a distance measuring device. This device has a housing 12, actuating elements 14 for switching the distance measuring device 10 on and off as well as for starting or configuring a measuring procedure. In addition to the actuating elements 14, the measuring device 10 has an output unit 16 in the form of a display for relating measurement results and for displaying information relating to the device status. A transmission unit 20 embodied in the form of a laser diode for generating an optical transmission measurement signal and electronic components of an evaluation unit are situated on an electronic support element, for example a printed circuit board 18, inside the housing 12 of the measuring device 10. The electronic support element 18 is fastened by fastening means, for example screws, to an optics support. The optics support also has a light passage 22, a deflecting unit 24, and receiving optics for concentrating measurement signal components into a receiver element. The transmitter unit 20, the light passage 22, the deflecting unit 24 for a reference 34, and a receiver unit 26 are only depicted schematically in FIG. 1.

In order to measure a distance of the distance measuring device 10 from a remote object, during operation of measuring device, a transmission measurement signal is transmitted by the transmitter unit 20 along a transmission path 28. The transmission measurement radiation exits the measuring device through a window 30 in the housing 12 of the device 10. The measurement signal that is reflected and scattered by the surface of a remote object to be measured travels back to the measuring device 10 via the reception path 29 and is partially coupled into the housing via a window 32. The reception of measurement signal is concentrated or focused by means of receiving optics not shown in FIG. 1 and is detected by a receiver element 26, for example a photo diode, in particular an APD. In alternative embodiments of a measuring device of this kind, the measuring device entry window and the receiving optics can also be embodied as integrally joined to each other.

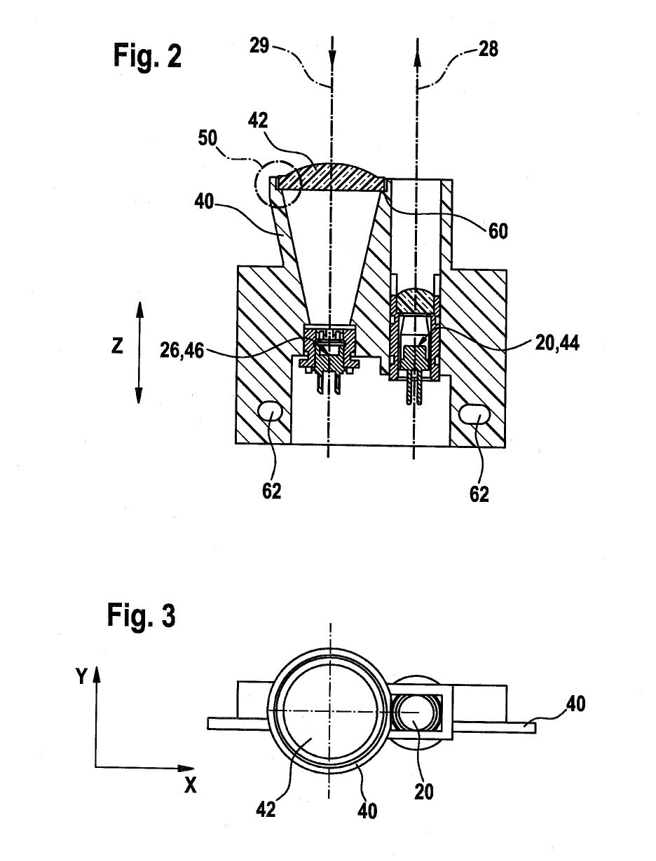

FIG. 2 is a view from below of an optics support 40, with a receiving lens 42 that has already been installed and adjusted. A transmitter unit 20, which is embodied in the form of a laser diode 44, and an associated collimation lens 46, which is for transmitting a collimated optical measurement signal along the transmission axis 28 of the optical measuring device, are fastened to the optics support 40. In addition, a receiver unit 26 in the form of a photo diode, in particular an APD 46, is also fastened to the optics support 40. For example, the optics support 40 can be the printed circuit board 18 itself or can be fastened to the printed circuit board. To that end, the optics support in the exemplary embodiment according to FIG. 2 has oblong holes 62 that permit the optics support to be fastened to the printed circuit board 18. For example, however, the optics support could also be composed of a separate metal or plastic structure, which is inserted into the housing 12 of the measuring device 10 together with a printed circuit board 18 and the optics support 40.

During adjustment of the optics 42, the laser diode 44 and the receiver 46 are already securely fastened to plastic support 40. In the method according to present invention, the collimation optics 42 must be adjusted so that measurement signal that is transmitted via the transmission path 28 and is reflected or scattered against an object to be measured, which is a certain distance away, is at least partially concentrated or formed into an image and projected via the reception path 29 onto the active surface of the receiver diode 46. In the context of the method according to present invention, the expressions “concentrated” or “formed into an image” are used synonymously.

In the method according to present invention, the alignment of the reception axis 29 and transmission axis 28 occurs by means of the receiving optics 42. The lens is moved into position in the X and Y directions (see FIG. 3) and secured in place. To that end, the receiving optics 42 can, for example, be grasped by a manipulator and placed in the desired position. Then, the position of the optics 42 is varied, optimized, and then fixed in place in the Z direction.

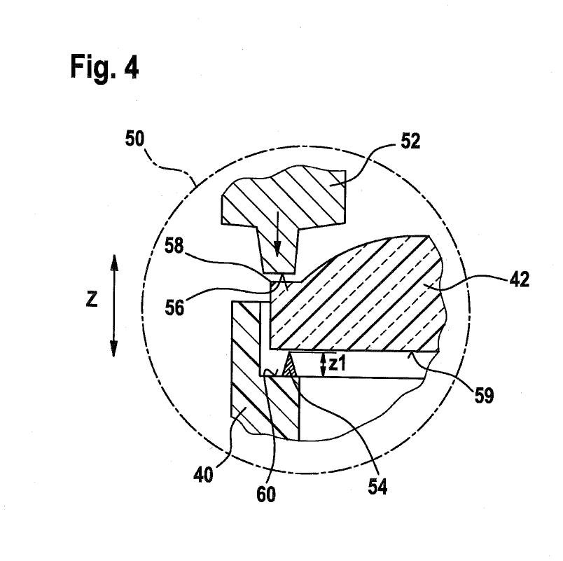

According to present invention, a welding process is used to execute both the adjustment of the lens 42 in the Z direction, i.e. the variation of the position of the lens in direction of Z-axis, and the fixing in place of the lens at the desired position z1 (see FIG. 4). The lens is moved into position in the X and Y directions before the welding and is then secured in place during the welding. The Z direction is adjusted, for example, by means of the duration of the welding procedure and checked by means of a length measuring system. In the embodiment shown in FIGS. 2 through 4, both the optics support 40 and the receiving optics 42 are composed of plastic. In this case, the welding procedure can be an ultrasonic welding procedure.

FIG. 4 shows a detail of the region 50 in FIG. 2. This detail shows the image-forming optics 42, the support edge 60 of the optics support 40, and the sonotrode 52 of an ultrasonic welding device. Embodied on the optics support 40 is an energy-conducting edge 54 in the form of a dome that tapers conically toward the lens 42. This energy-conducting edge 54 can be integrally joined to the optics support, particularly if the latter is made of plastic. In alternative embodiments, the optics 42 can likewise have a corresponding energy-conducting edge and the energy-conducting edge used in the method can simply be embodied on the optics, for example can be integrally joined to the optics. The sonotrode 52 is pressed with its contact surface 56 against the edge region 58 of the optics 42 so that the optics are likewise pressed against the energy-conducting edge 54 of the optics support 40. The acoustic waves coupled into the optics 42 by means of the sonotrode 52 heat the plastic material of both the optics 42 and the energy-conducting edge 54. As a result, the energy-conducting edge 54, due to the way it tapers to a point, heats up more intensely than the solid body of the receiving optics 42. By adjusting the welding parameters, it is possible to adjust the lens body 42 in the direction of the Z-axis. Consequently, the distance z1 between the side of the optics 59, which is flat in the exemplary embodiment, and the contact edge 60 of the optics support 40 can be adjusted, for example, by means of the energy that is coupled in or by means of the pressure that the sonotrode 52 exerts on the lens body 42, in that the energy- conducting edge 54 is melted with greater or lesser intensity and is deformed by means of the pressure transmitted to the lens body 42 by the sonotrode 52.

The lens 42 of the image-forming optics must be adjusted in the Z direction to a definite distance from the detector element of the receiver diode 46. Typically, the adjustment range is approximately ±0.2 mm. The precision requirements in the adjustment process are approximately one order of magnitude over the adjustment range. Through a corresponding dimensioning of the energy-conducting edge, which is embodied on the optics support 40 or on the lens 42, it is possible to adjust the distance setting z1 between the lens and the optics support and consequently between the lens 42 and the receiver element 46 by means of various welding parameters such as the interaction time, the pressure exerted, or the frequency used. A typical dimension for the height of the energy-conducting edge here is between 0.1 mm and 1 mm, with a preferred height in the vicinity of approximately 0.5-0.6 mm.

In the method according to present invention, the alignment of the reception axis 29 with the transmission axis 28 consequently occurs through the adjustment of the receiving lens. The adjustment of the receiving lens 42 can occur, for example, through observation of the signal strength of the measurement signal arriving at the receiver 26. Alternatively, a length measuring system can make sure that a previously determined definite distance is set between the underside of the lens 59 and the active surface of the reception diode 46.

A process of this kind can advantageously be automated in that for example, the reception signal of a receiver diode 46 detected during the adjustment or a signal of a length measuring system can be used to control the interaction time, the pressure, or other parameters of the laser welding device. In particular, a closed control loop can be implemented, which permits an automatic adjustment of the optics in three axes.

After the welding, the lens is both aligned and fixed in place by the welding together of the plastic components of the lens and of the support and energy-conducting edge. With the method according to present invention, it is not necessary to additionally secure the optics by means of adhesive or clamping screws.

The method according to present invention permits the simple, rapid adjustment of an optical system. With this method, the lens is adjusted and not the electronic components of the system. Additional fixing elements for subsequently securing a completed adjustment are not required.

The method according to present invention and a measuring device manufactured using this method are not limited to the exemplary embodiment shown in the drawings and disclosed in the description.

In particular, the method according to present invention is not limited to the use of an ultrasonic welding process. It is just as possible, for example, to use a laser welding process, in particular a penetration laser welding process in which, for example, the optical welding signal in the form of an infrared laser beam is transmitted nearly completely through the optics and is absorbed in the optics support and in a correspondingly embodied energy-conducting edge so that both the energy-conducting edge and the adjacent regions of the optics are melted and are thus solidly joined. By providing different additives to the work pieces to be joined, it is possible to adjust their transmittance and absorption capacity with regard to the respective welding wavelength used.

What is claimed is:

1. A method for assembly and adjustment of an electro-optical device in which optics (42) are aligned in three axes (X; Y; Z) in relation to another component (26, 46), in particular a method for adjusting receiving optics (42) in relation to an optical receiver (46),
wherein the optics (4) are first adjusted in a first direction (X) and second direction (Y) and the optics (42) are then fixed in place on an optics support (40) in the third direction (Z) by means of a welding process.

2. The method as recited in claim 1,
wherein the position (z1) of the optics (42) in the third direction (Z) is adjusted by means of at least one parameter of the welding process.

3. The method as recited in claim 2,
wherein the position (z1) of the optics (42) in the third direction (Z) is adjusted by means of the time duration of the welding process.

4. The method as recited in claim 1,
wherein the optics (42) and/or the optics support (40) has at least one energy-conducting edge (54), which produces a solid connection between the optics (42) and optics support (40) after completion of the welding process.

5. The method as recited in claim 4,
wherein the position (z1) of the optics (42) in the third direction (Z) is adjusted through the dimensioning of the energy-conducting edge (54).

6. The method as recited in claim 2,
wherein the position (z1) of the optics (42) is adjusted by means of a pressure of the welding device.

7. The method as recited in claim 1,
wherein the optics (42) are composed of plastic.

8. The method as recited in claim 1,
wherein the welding process is an ultrasonic welding process.

9. The method as recited in claim 1,
wherein the optics (42) are adjusted so that the optical axis (29) defined by the optics (42) is, at a certain distance, aligned centrally with a second optical axis.

10. A measuring device, in particular an optical distance measuring device (10), having at least one image-forming element (42) and one receiving element (26, 46), adjusted in accordance with a method as recited in claim 1.
